(19) United States
(12) Patent Application Publication
(10) Pub. No.: US 2004/0242096 A1
(43) Pub. Date: Dec. 2, 2004

(54) Net reinforced composite

(76) Inventor: Amit Prakash, Hudson, OH (US)

Correspondence Address: David L King Sr, 5131 NE County Road 340, High Springs, FL, 32643, US

(21) Appl. No.: 10/778,450

(22) Filed: Feb. 13, 2004

Related U.S. Application Data
(63) Continuation-in-part of application No. 10/444,363, filed on May 27, 2003.

(51) Int. Cl. B32B 27/04; B32B 27/12; B32B 5/02; B32B 15/08; B32B 15/01

(52) U.S. Cl. 442/19; 442/6; 442/7

(57) ABSTRACT

A composite material having a polymer or a metal matrix wherein reinforcement is achieved by one or more of a net or a mesh or a screen structure. Openings in the net structure are filled with the matrix to form a good mechanical bond. High strength and high modulus wires, preferably steel wires can be used to make the net structure. Nets can be placed at a desired plane with respect to the neutral axis of the structure to optimize bending and other properties.

### CROSS REFERENCE TO RELATED PATENT APPLICATIONS

This invention is a Continuation-In-Part application claiming priority to co-pending U.S. patent application Ser. No. 10/444,363 filed May 27, 2003 entitled “Composites reinforced by wire net or mesh for light weight, strength and stiffness”.

### FIELD OF THE INVENTION

This invention relates to composite structures or materials which have at least a matrix and one or more reinforcing materials.

### BACKGROUND OF THE INVENTION

Composite materials are used for their stiffness and strength. They are composed of at least two components commonly known as matrix and reinforcing materials. Reinforcing materials usually are in the form of plates, fibers or particles. Fiber reinforced composites utilize either random or oriented fine fibers. Common reinforcing fibers include but are not limited to polyester, rayon, fiberglass, carbon, nylon, silicon carbide, and wire by way of example. The matrix material can be a polymer, metal or ceramic. Typically, the reinforcing material is embedded in the matrix material to form a composite material or structure commonly referred to simply as a composite.

Most composites require a good chemical bond between the matrix and the reinforcing components for an efficient stress transfer at the interface. A compatible fabric coating and/or suitable cement property of the matrix is required to achieve a good chemical bond. This additional bonding agent adds a further component and additional complexity in the manufacturing of such chemically bonded composites.

Referring to prior knowledge evidenced in the following patents composites show a wide variety of forms and end uses. U.S. Pat. No. 5,908,685 proposes that continuous fibers of different modulus placed on different layers can develop direction dependence stiffness in the composite. This was particularly advantageous in conveyor belts and runflat tires. U.S. Pat. No. 6,546,694 B titled ‘light weight structural panel’ proposed a sandwich construction comprising of high modulus material plates bonded on either side of a low modulus matrix. Such light weight, high strength panels have found many uses in aircraft. Conveyor belts and similar structures use continuous fibers of metal or non-metal to obtain desired stiffness and strength as for example, is discussed in U.S. Pat. No. 3,900,627 assigned to Industrie Pirelli S.P.A. of Italy. U.S. Pat. No. 3,607,592 proposes multiple plies of wires sandwiching a textile ply in rubber matrix to gain overall stiffness in a structure used as a temporary road. The above patents and other references take advantage of reinforcing a soft matrix by rigid components which is attached by a chemical bond and do not point to a network of fibers in one plane.

U.S. Pat. No. 6,533,977 B1, however, shows a wire mesh as a starting material for washers or gasket material for automotive exhaust seals where strength is directed to compressive type forces. U.S. Pat. No. 5,856,243 proposes a net of hybrid yarn with low melting bonding yarn to make bituminized roofing and sealing membranes. Here the reinforcement is based on developing a chemical bonding between the fiber and the matrix. U.S. Pat. No. 5,337,693 proposes new concepts of flexible internal liners for oil tankers and suggests a net structure made of any of the common fibers to develop such a flexible liner. The liner employs flexible oil resistant impermeable plastic or rubber reinforced by steel mesh or woven animal fibers and can be used to limit oil spills.

Woven textiles made of fiberglass or silicon carbide or carbon fibers in conjunction with an adhesive cement matrix are commonly used to make or repair structures. In such cases, due to lower rigidity of the fabric and other natures of the fibers such as off axis ductility etc., total strength gained by the composite is a lower percent of the total original fiber strength.

An objective of the proposed technology of the present invention is to enhance the properties of a composite material by using wires which are generally straight for higher mechanical efficiency.

Further objectives are (a) to achieve improved mechanical bonding with the matrix, (b) to provide appropriate directional reinforcement and (c) in case of bending, to keep all fibers within a respective net structure on the same nominal distance from the neutral axis providing desired stiffness, and to gain on stress carrying capacity by using high strength fibers where needed. An overall objective is to provide a very efficient and inexpensive composite.

### SUMMARY OF THE INVENTION

The present invention utilizes the advantage of predominantly mechanical bond between a reinforcing wire, fiber or cord network and the matrix. A net or mesh structure made of long and generally straight wires, fibers or cords crossing in angular relation, preferably interwoven to form a pluraty of openings to reinforce a matrix of plastic, elastomeric material or metal is disclosed.

The matrix material mechanically grips the net or mesh structure more effectively by using these openings. This interlocking mechanical bond should last much longer than the prior art chemical bonds. The direction of the wires, fibers, or cords in the net or mesh can be calculated to optimize the reinforcing needs. Fiber, wire and cord may be used as a reinforcing material. Similarly, mesh, net and screen, may be used as the reinforcing structure. It being understood that many specific variations in such components and structures can yield strikingly different performance characteristics when used in combination with specific matrices.

One embodiment of the present concept employs a net type structure having a substantially straight wire, cord or fiber network with periodic openings to reinforce the matrix. The net structure allows significant mechanical bonding between the wires, cords or fibers and the matrix. The use of net or mesh is easy in manufacturing the composite and provides significantly higher percentage of strength return with respect to total individual wire strength when compared to the prior art composites.

The inventive composite structure which has at least two material components, one being a matrix and another being a reinforcing structure is summarized below. The matrix component is a polymer or a metal material or similar composition of matter while the reinforcing structure is a net structure.

The net structure is made of substantially straight wires to preserve a higher percentage of the wires original tensile strength. These straight wires when formed into a net structure are oriented or run in multiple coplanar axes. The net structure has periodic openings due to the arrangement or the orientation of the wires. The periodic openings provide a means for mechanically locking the net structure with the matrix material.

The wires of the net structure have a modulus substantially higher than the modulus of the matrix.

In one embodiment of the present invention the wires preferably are steel. The wires have a strength in the range of 2000 MPa to 6000 M Pa. Each wire has a diameter in the range of 0.03 mm to 6 mm.

The wires can be formed as a cord. The cord has two or more wires or filaments wrapped or otherwise stranded together. Typically, when wrapped the wires form a helix having an angle in the range of 60 to 90 degrees. The cords may be used in combination with monofilament wires in the net structure. The present invention can employ the cords in at least one direction of the multi-directional net structure.

The invention may have the wires free or not rigidly joined at intersections. Alternatively, it may have the wires rigidly joined at intersections by means of welding or other bonding techniques.

The composite may have only one net structure forming at least a bi-directionally reinforced composite or may have multiple net structures stacked, preferably parallel to each other. The stacked net structures can be spaced or can have some net structures partially contacting another net structure over some or all of the area occupied by the net structures.

The net structures can be completely embedded internal of the matrix or can be external to at least one side of the matrix mechanically attached at the periodic openings to insure adequate strength is maintained. Additionally, the wire arrangements or orientations can be optimized for different strengths in different directions creating a multi-directional reinforced composite. In one embodiment the matrix of the composite may be made of a ceramic material or a polymeric material or a metal. The ceramic material may include glass or cement. Additionally, the polymeric material may include an asphalt mixture. The polymeric material can be a reclaimed or reprocessed material or a virgin material or a combination of such materials. The polymeric matrix may include fiber reinforcing materials such as carbon fibers, glass fibers, or aramid. When the matrix is a metal it can be aluminum, aluminum alloy or other metal of a modulus less than the wires of the net structure. When the matrix is ceramic or asphalt mixture the steel wires must have a strength of 1,500 MPa or greater, preferably 2,000 MPa.

Definitions

“Coplanar” as used herein means when referring to the net structure, the orientation of the wires when laid flat or formed into a flat woven wire cloth or mesh and prior to assembly into the matrix to form an article which may be flat or otherwise curved.

“Cord” means one or more of a reinforcing element, formed by one or more filaments or wires which may or may not be twisted or otherwise formed. Therefore, cords using the present invention may comprise from one (monofilament) to multiple filaments. The number of total filaments or wires in the cord may range from 1 to 134. Preferably, the number of filaments or wires per cord ranges from 1 to 49.

“Filament” or “wire” is used herein for all strand materials whether a single filament or a cord formed of many filaments. The filaments may be steel, organic, or any other strand material.

### BRIEF DESCRIPTION OF THE DRAWINGS

The invention will be described by way of example and with reference to the accompanying drawings in which:

FIG. 1 is a perspective view of a composite, having only one layer of a wire net embedded in a matrix, and spaced away from the mid axis, the breakaway portion of the view shows a net structure mechanically locked with the matrix. As shown, all wires of the net are substantially on the same plane, therefore will contribute maximum to bending stresses.

FIG. 2 shows a perspective view of a stack of multiple nets, 21, 22, 23, and 25 of different wire types which can be used in combination to reinforce a composite. The combination of nets forms a wire network of net structures oriented and sized as per calculated need or application.

### DETAILED DESCRIPTION OF THE INVENTION

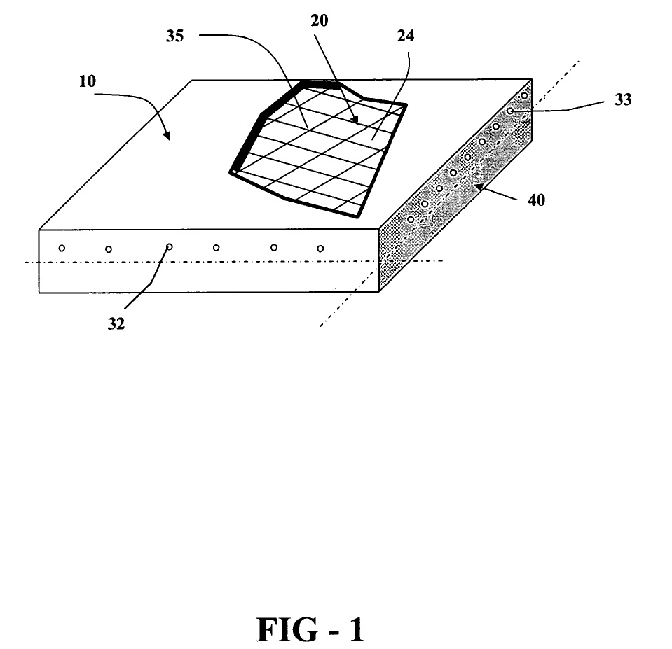

With reference to FIG. 1 a composite 10 is shown, the composite uses a net or mesh structure 20 made of long and generally straight cords, fibers or wires 32, 33 to reinforce a matrix 40 of plastic, or ceramic, or a polymer of rubber, or a metal.

The matrix 40 grips the net structure 20 by mechanically interlocking by using the openings 24 in the net structure 20. This mechanical interlocking, if not eliminating, at least substantially reduces the requirements placed on the chemical bond.

As shown, the net 20 has the wires 32, 33 oriented in two directions in a substantially singular plane forming a bi-directionally reinforced composite. The wires are preferably woven to form a wire cloth or mesh. The wires 32, 33 can be single strands or filaments which are interwoven to form a mesh or net structure 20 or alternatively, the wires can be formed into multiple strands or filaments such as a cord of steel wire which is woven to form the mesh or net structure 20. These cords can achieve more strength than single strands typically. Such a net structure 20 can have the wires 32, 33 not physically attached at the intersections 35 or the intersections 35 can be rigidly attached by welding or other means of attaching. Intersections 35 that have been welded may need to be stress relieved or further heat treated to reach the desired strength or toughness level.

The net structure 20 when formed as a mesh has the wires or cords 32, 33 running along two or more axes at desired angles on a substantially flat plane P of the mesh. The space between the wires or cords 32, 33 form openings 24. These openings 24 provide a gap or void in which the material of the matrix 40 can penetrate. This penetration creates the mechanical interlocking.

In one embodiment the net structure 20 is formed by a thin plate with openings 24 spaced in a periodic opening network. Expanded metal mesh is another example of alternatives to woven or wire cloth net structures 20. Each of these alternative net structures 20 can be made of steel or metal alloy of a high strength.

The diameter of an individual wire or filament 32, 33 that is used in the net structure 20 and encapsulated in the matrix 40 or used in a cord that is encapsulated may range from about 0.03 to 6 mm. Preferably, the diameter ranges from 0.10 to 5 mm. The tensile strength of the steel filaments in the cord should be at least 1500 MPa, preferably 2000 MPa to 6000 MPa or at least 3000 MPa—(1200.times.D) when D is the diameter of the filament. Most preferably, the tensile strength of each filament ranges from about 3000—(1200.times.D) to 4400 MPa—(2000.times.D).

Preferably, the wires 32, 33 are coated or plated with brass, zinc, nickel or “chemlock” adhesives to enhance adhesion or corrosion resistance when embedded in the matrix 40. The wires 32, 33 may also be coated by a hard abrasion resistant coating including a wear resistant material such as tungsten carbide to improve wear resistance. The wires 32, 33 may include AISI grades 1070, 1080, 1090 and 1095. The steel may additionally contain varying levels of carbon and microalloying elements such as Cr, B, Ni and Co.

When employed in the net structure 20 the openings 24 preferably are spaced to create a void having a width, length and depth each being greater than or equal to the adjacent wire diameter, typically 0.03 to 6 mm or greater dependant on the wire diameter. These openings 24 can of course be larger if so desired, however, if the openings become too small the matrix material will have difficulty penetrating the net structure to form the desired mechanical interlocking.

Additionally, in some applications the composite may improve in overall toughness and impact resistance if coated by or pre-treated with a polymer or elastomer. This material while improving bonding in some cases has the further unexpected benefit of providing a limited movement of the wires 32, 33 relative to the matrix 40. As can be appreciated such a minute movement of the wire 32, 33 greatly increases the shock and energy absorbing capacity of the composite. Advances in adhesive and polymer coatings have made it possible to provide very thin coatings to wire filaments 32, 33. In one example it is possible to coat wires with less than 1 to 2 micrometer and less for the treatment of tire cord as was recently taught in U.S. Pat. No. 6,676,998. These coatings can be low viscosity water based latex or even high viscosity oil based mixtures having a viscosity of 100 SUS and higher. These thin coatings of polymer make it easier to weave a coated filament or wire into a net structure 20. Coated electrical wire for example uses 1 mil and thicker coatings.

Alternative ways of dip coating the entire net structure are also feasible such a dip process wherein a single wire or the entire net structure 20 can be coated and the openings 24 are blown open or ultrasonically vibrated to prevent the polymer coating from occluding the openings.

The combination of a high strength wire 32, 33 coated with a shock absorbing polymer coating 50 when formed in a net structure 20 and embedded in a matrix material 40 has shown dramatic increases in impact strength and energy absorbance as well as fatigue resistance. In certain applications, the wires 32, 33 of the net structures 20 are covered by a polymer or metal harder than the wire material such as tungsten carbide while maintaining the openings 24 open.

Resin style composites such as Kevlar or carbon fiber have been known to have flexure fatigue issues as well as shock wave and impact limitations although both materials have been used in may aircraft and ballistic barrier protection devices.

The present invention dramatically improves the performance of such composites.

The composite with a matrix mechanically locked to a net structure can greatly improve the toughness of the composite.

In one test of the present invention, a polyester resin based composite having 18 volume percent wire net, wherein the wire strength was 110 KSI, showed a composite strength of 13.5 KSI, modulus of 1.7 MSI, total percent elongation 35% and a notched Izod toughness of 29 ft-lb/in. This represents an increase in notched izod toughness of 2 or more times over comparable strength composites. Advanced bi-directional composites of high strength in the range 15 to 50 KSI have been developed, but when compared to the present invention, these advanced bi-directional composites, such as Kevlar reinforced epoxy or glass reinforced epoxy composites, would be less than half the notched izod toughness. Only enhanced advanced bi-directional composites that have been enhanced through costly additives of additional toughening agents which are not comparable to the present invention can even approach the toughness achieved by the present invention.

Following are the results from three point bending tests conducted over a 15 cm span. Test piece dimension was: 5.6 mm thick×19.0 cm long×8.9 cm wide. Sample-1 had only a polyester liquid resin with a hardener mix and was allowed to set for 7 days. In Sample-2, the filler matrix was same as Sample-1 plus two wire nets made of steel wires placed approximately 1 mm under the top and bottom surfaces of the thickness. The net comprised of 0.56 cm diameter wires, running at 90 degree axes, at 1.574 square patterns per cm square area density. At intersections wires were rigidly welded. In the three points bend test, the bending stiffness doubled for the net reinforced plate, Sample-2.

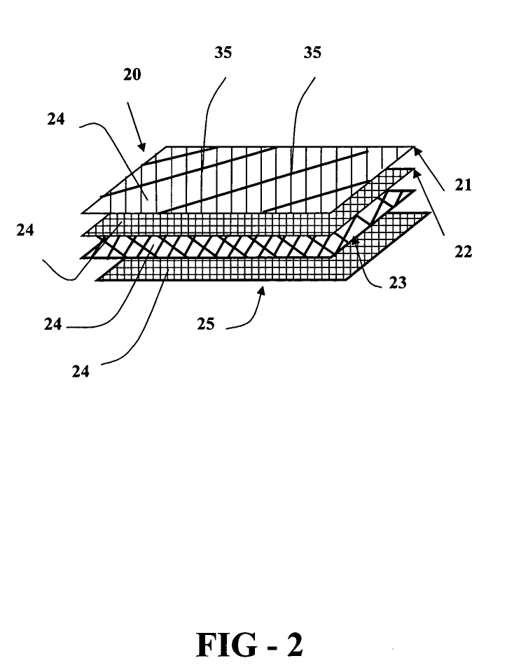

With reference to FIG. 2 the composite 10 may employ multiple net structures 20 having nets 21, 22, 23, 25. This use of multiple net structures 20 permits the use of wire meshes or net layers 21, 22, 23, 25 of different structural properties and strengths to tune the composite to particular physical characteristics. Each mesh or net layer 21, 22, 23, 25 may have different opening sizes to increase or decrease the amount of penetration of the matrix material 40. The composite 10, when formed with one or more of the net structure 20 having layers 21, 22, 23, 25 placed depending upon the application load condition can have the adjacent net structures 20, 21, 22, 23, 25 in contact with each other to help improve the shear property. The placement of net structures 20, 21, 22, 23, 25 can be done by any standard practice such as pouring liquid polymer or metal, thermally pressing the nets into the matrix, or pre-laminating the nets and then chemically or thermally attaching the laminates together. Bending stiffness can be enhanced by strategically spacing net or mesh layers 20, 21, 22, 23, 25 within the composite 10. This effectively increases the moment of inertia similar to the flanges of an I-beam. Similarly, the torsional stiffness can be tuned by changing the angular orientation of the wires 32, 33 with the spaced apart net structures 20, 21, 22, 23, 25 which increases the bi-directional reinforced effect to a multi-directional reinforced composite.

The wire net structures 20 may be used in conjunction with and separated by low density rigid materials such as honeycomb structures, wood, metal foams to increase bending stiffness while reducing weight. The wire net structures 20 can be strategically locally positioned in the areas of high stress, such as a hole or a corner to improve toughness which would slow crack propagation.

These and other design performance enhancements are possible when the composite employs the net structure in a matrix.

The present invention is believed to be far superior in toughness to conventional composites such as fiberglass and other thermoplastic and thermoset resins and polymers.

It is important to understand that the present invention with a net structure can be used with resins forming the matrix that additionally have one or more other reinforcing fibers such as carbon, fiberglass, or Kevlar. The other reinforcing fibers can be in random or in oriented fiber form.

The matrix when a ceramic may be glass or the matrix material may even be asphalt or a cement type mixture like concrete. By coating a high strength wire net in a protective coating by embedding the net in a polymer with the openings 24 between the wires 32, 33 open the net structure can be placed into the cement or asphalt or the cement or asphalt poured onto the net to create the net reinforced asphalt or concrete. Preferably the brass plated wire net 20 can be coated with rubber, cured and then used for reinforcing asphalt or concretes. In these applications the wire should be of high strength of 1500 MPa or greater.

The composite 10 has numerous practical applications in aircraft structural members, light weight marine boat hulls, automobile chassis, frames and bodies, ballistic projectile barriers, commercial and residential building structures, space and electronics industry, toys, roadways and sporting goods to name a few. The present invention enables the composite structure to be tuned and constructed to meet a variety of different physical parameters.

As used throughout the specification, the composite is shown as a flat sample having wires of the net structures in a flat panel orientation. It is understood however, most articles of manufacture may have curvatures, bends and other shapes well beyond flat, accordingly the use of the term coplanar as it refers to the net structure is intended to refer to the orientation of the wires when laid flat or formed into the net structure but does not mean that once incorporated into the composite, the composite is limited to flat structures but in fact includes almost any curvative shape imaginable. To accommodate irregular shapes the net structure 20 may be cut or multi-pieced to achieve appropriate bends by way of example.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A composite material structure comprising:
a matrix, the matrix being a polymer or a metal material;
a reinforcing structure, the reinforcing structure being a net structure formed of substantially straight wires oriented at multiple substantially coplanar axes as formed and prior to being joined to the matrix to form the composite; and
wherein the net structure has periodic openings due to the arrangement of the wires filled by the matrix material when joined to provide mechanical locking of the matrix and the net structure, the wires being of a higher modulus relative to the matrix.

2. The composite of claim 1, wherein wires in at least one direction are in the form of a cord having a helix angle between 60 and 90 degrees.

3. The composite as claimed in 1, wherein the reinforcing wires are steel wires of strength in the range of 2000 to 6000 MPa.

4. The composite of claim 3, wherein the individual wire diameter is between 0.03 to 6 mm.

5. The composite of claim 1, wherein the intersecting wires are not rigidly joined.

6. The composite of claim 1, wherein the intersecting wires are rigidly joined.

7. The composite as claimed in 1, wherein the matrix is a reclaimed polymeric material.

8. The composite as claimed in 1, wherein the matrix is a fiber reinforced polymeric material.

9. A composite as claimed in 1, wherein the matrix is metal.

10. A composite as claimed in 1, wherein the matrix is an alloy of aluminum.

11. A composite as claimed in 1, wherein multiple net structures are stacked parallel to each other.

12. The composite of claim 1, wherein multiple wire nets are stacked in such a manner that some or all is in contact to its adjacent net.

13. A composite as claimed in 1, wherein the wire net structure is embedded in the attached matrix mechanically adjacent to at least one external side of the matrix to gain bending stiffness.

14. A composite as claimed in 1, wherein the net comprises of wire arrangements to yield different strength in different directions.

15. The composite material structure of claim 1, wherein the periodic openings in the net structure have a width, a length, and a depth each being equal or greater in size than the smallest diameter of the wires of the net structure.

16. The composite material structure of claim 1 further comprises:
a wire coating, the coating being applied to wires of the net structure.

17. The composite material structure of claim 1, wherein the wire coating is an adhesive coating or elastomeric material having a thickness of 0.1 micrometer or greater.

18. The composite material structure of claim 17, wherein each wire is individually coated.

19. The composite material structure of claim 17, wherein the net structure is coated with a coating thickness of 0.1 micrometer or greater.

20. The composite structure of claim 1 wherein the composite is a component of one of the following; an aircraft, marine boat, an automobile, a toy, a sporting good, an appliance, a building structure, an electronic device.

21. The composite structure of claim 1 wherein the wires of the net structure are coated or plated with one or more of the following: brass, zinc, nickel, chemlock, tungsten carbide.

22. The composite structure of claim 21 wherein the coated wires are embedded in a polymer protective coating.

23. The composite structure of claim 22 wherein the polymer protective coating is a vulcanized rubber.

24. The composite of claim 1 wherein the matrix is a ceramic including concrete, glass or a polymeric mixture of asphalt, and wherein the structure has wires having a tensile strength of 1500 MPa or greater.

25. The composite of claim 24 wherein the wire diameter or cord diameter is less than 6 mm.
